(19) United States
(12) Patent Application Publication
(10) Pub. No.: US 2003/0057137 A1
(43) Pub. Date: Mar. 27, 2003

(54) Cartridge sorting machine

(76) Inventors: Rudy Wojtecki, Mantua, OH (US); Jerry Spence, Ravenna, OH (US)

Correspondence Address: American Automated Technologies, LLC, 772 True Industrial Parkway, Ravenna, OH, 44266, US

(21) Appl. No.: 09/957,135

(22) Filed: Sep. 21, 2001

(51) Int. Cl. B07B 1/00

(52) U.S. Cl. 209/1

(57) ABSTRACT

An automated machine which separates live ammunition from spent (fired) cartridges for the purpose of recycling the metal from the cartridges. Live rounds create a hazard in the recycling process. The machine separates the live rounds from the spent cartridges by flowing the cartridges along a V shaped track and removing the lighter spent cartridges by means of air jets positioned along the track. Various calibers of ammunition can be sorted simultaneously by the machine.

### BACKGROUND

Recycling ammunition cartridges used in small weapons after firing is necessary to minimize the cost of training and qualifying personnel primarily in the military and law enforcement. Recycling the brass metal from spent (fired) cartridges involves melting the cartridges to enable the metal to be reused. This process of melting can be hazardous if live rounds are inadvertently mixed in with the spent cartridges. Injuries and fatalities have been experienced by the military because of this hazard. Present methods of removing the live rounds from the spent rounds to be recycled involves manual sorting which is tedious, expensive, and unreliable. The machine described by this proposal was conceived to satisfy this need to be able to remove any hazardous live rounds of ammunition from large quantities of spent rounds with a high degree of reliability and a minimum of human labor.

### DESCRIPTION

Cartridge Sorter

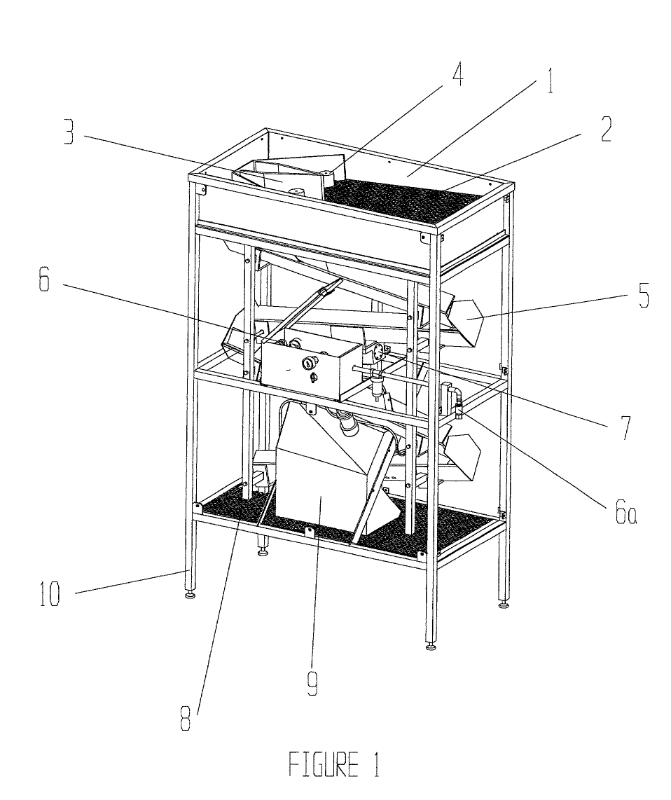

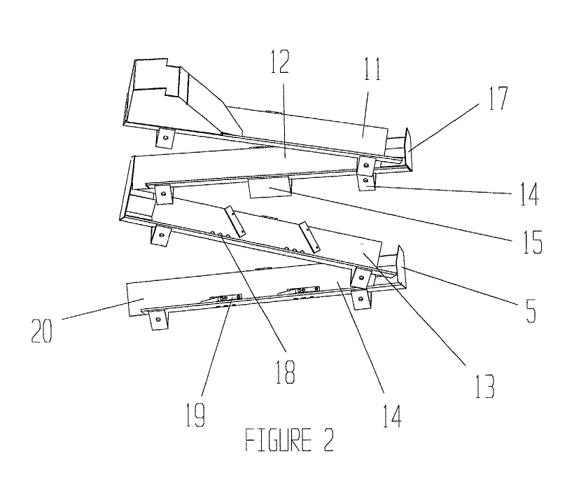

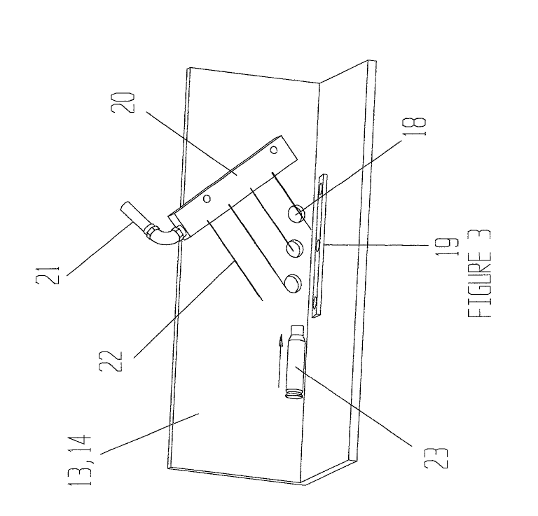

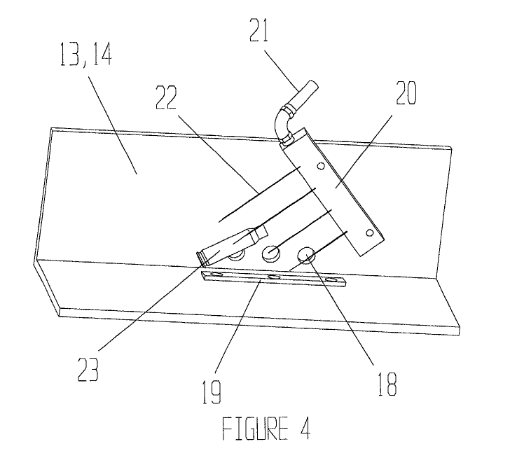

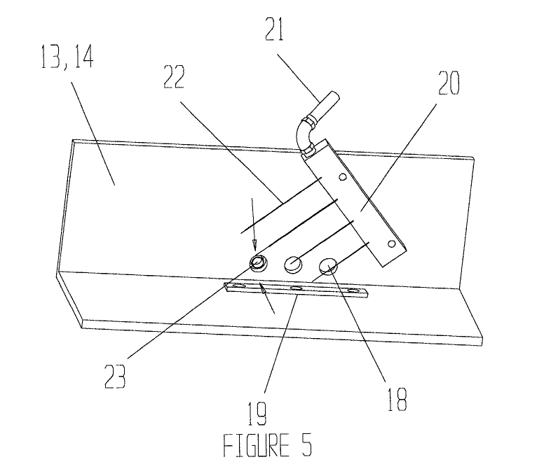

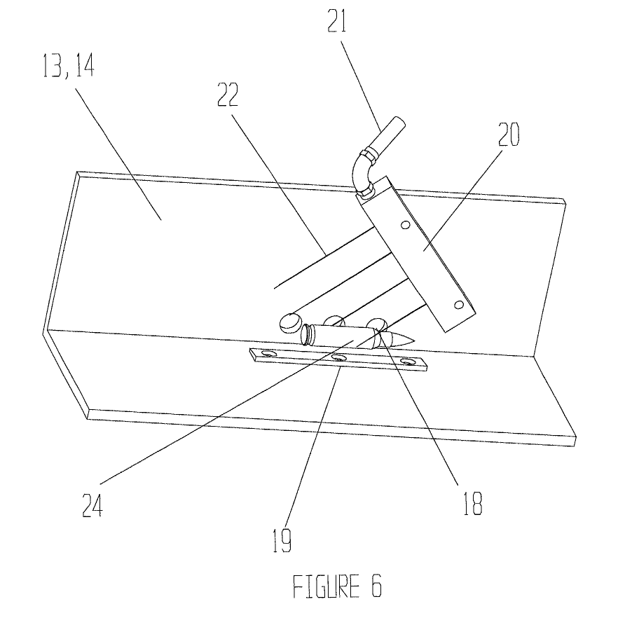

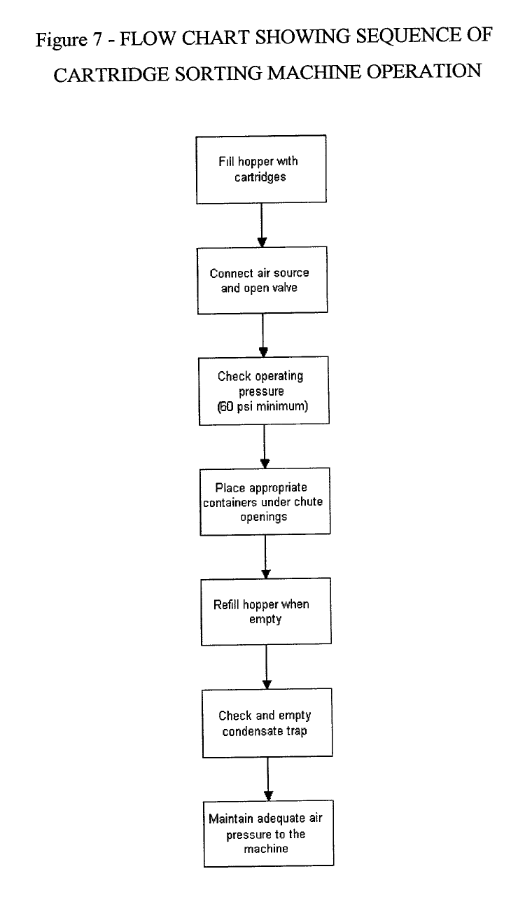

The preferred embodiment of the cartridge sorting machine is shown in FIG. 1. Said machine separates live cartridges 24 containing propellent and bullets which are heavier and have a streamlined end (bullet) from spent (fired) cartridges 23 which have an open end and are lighter since no propellent or bullet are present in the cartridge by imposing a jet of air 22 on the end of the cartridge as it slides down a track assembly FIG. 2. Live cartridges are heavier and are streamlined so an air jet set to deflect a lighter open ended spent cartridge cannot lift them to allow deflection and separation to take place. Said spent rounds being lighter and having an open end allow the air jet to deflect the cartridge and position it so it can fall through a strategically located hole 18 into a chute 9 and be removed from the track. Live cartridges slide past the air jets and continue through the track to the end 20 where they are dropped into an appropriate container. Spent cartridges are separated at stations FIGS. 3, 4, 5, 6 containing the air jets and separation holes along the track and drop into a chute 9 which guides them to an appropriate container.

Sliding motion of the cartridges in the tracks 11,12,13,14 is produced by gravity and vibration. The tracks 5 are V shaped to cause the cartridges to flow along a common axis and are positioned at an angle just below the angle of repose for brass on steel to allow the movement of the cartridge to be controlled by the vibration imposed on the track. The tracks and the hopper are rigidly coupled to a pneumatic vibrator 7 which produces a sinusoidal displacement having a frequency and amplitude which varies with the pressure of the compressed air to the vibrator. The machine pressure is controlled by common pneumatic regulators in the pneumatics assembly 6. The amplitude and the frequency of the vibration determine the velocity of the cartridge movement along the track. The velocity of movement must be controlled to allow the air jets to be set at an effective angle and pressure and consistently produce the desired deflection. Multiple tracks may be necessary to increase thruput and reliability.

Hopper

The hopper 1 is designed to hold a desired quantity of cartridges and dispense the cartridges to the tracks. The hopper has an expanded metal floor 2 which allows dirt and debris to be sifted away from the cartridges. The hopper is slanted to direct the cartridges to a shaped opening with a weighted door 3 which dispenses the cartridges to the track 5 with the proper feed to allow the track to hold the cartridges in queue. The hopper is linked to the vibrator motor 7 and is vibrated with sufficient energy to activate the cartridges to move to the track. Said energy is supplied by an external compressed air source having a pressure between 60-120 psi and controlled by the internal pneumatic air conditioning system 6.

Orienting Track

The orienting tracks 11, 12 function to get the cartridges in queue after falling from the hopper opening. The tracks are of sufficient length to orient and smooth out the flow of the cartridges. Said tracks are shaped to control flow to prevent an excessive number of cartridges to move down the track and to develop a flow pattern before the cartridges get to the sorting tracks. At the end of the top track 11 the cartridges must fall through a shaped chute 17 which attempts to orient the cartridges open end forward. Because of the throughput required to make the machine a practical device the cartridges are traveling at a velocity which will allow a portion of the cartridges to pass through the orienting port primer end forward so the same port arrangement has been placed at the exit end of each track to ensure correct orientation as the cartridge passes into the sorting stations FIGS. 3, 4, 5, 6.

The ideal flow pattern is a single stream of cartridges moving end-to-end with the open end forward. The orienting track smooths out the flow of cartridges and gets the flow to a single line of cartridges.

Chutes

At the end of each track chute 5, 17 orients the cartridge falling from the end of the track to move with the primer end last. The chute is shaped and located to guide the heavier end of the spent cartridge to a proper position on the chute before allowing the cartridge to drop to the track below in proper position with primer end last.

Sorting Track

The sorting tracks 13, 14 have a plurality of holes 18 slightly larger than the diameter of cartridges 23, 24 being sorted. Air jets blocks 20 are strategically located over the holes 18 and in correct proximity to allow the jets 22 to deflect the open end of spent cartridges 23 allowing said cartridges to pass through the holes while allowing the heavier closed end live cartridges 24 to pass further along the track. Cartridges flow down the sorting track and are deflected by jets of high velocity air only if proper weight and shape (spent) heavier live rounds are not deflected and continue down to the end of the sorting track.

Ducts 14 under the sorting track holes guide the spent cartridges passing through the sorting holes. The spent cartridges passing through the holes are guided by the duct to fall into an appropriate container. An outlet at the end of the sorting track allows the live cartridges remaining in the track to fall into an appropriate container separate from the spent cartridges.

Thruput and reliability of the machine may be increased by using multiple tracks. The plurality of tracks may be in series or in parallel. Prototype machines tested have two orienting and two sorting tracks in series. Track length may also be varied to increase operational reliability.

Cover panels are attached to the frame of the machine to provide a protective enclosure and to reduce the level of the noise generated by the machine during operation.

What is claimed is:

1. A machine capable of separating live ammunition from spent cartridges comprising:
a. A vibrating hopper to hold a quantity of cartridges with an opening at one end to allow a controlled number of cartridges to exit said hopper and fall onto a track.
b. A V-shaped orienting track to align the cartridges end-to-end. Said track is V shaped to guide the cartridges along the axis of the track and is also vibrating and slanted to direct the cartridges toward the opposite end of the track. Cartridges moving along said track fall off the end and are guided by a chute
c. Cantilevered gates on said orienting track to further orient and smooth out the flow of the cartridges. The cantilevered gates are counterbalanced to provide sufficient restriction to flow to prevent an excessive number of cartridges to move down the track and to develop a flow pattern before the cartridges get to the sorting track.
d. A chute to orient the cartridges with primer end last with respect to the cartridge motion.
e. A V-shaped sorting track said track having a plurality of holes slightly larger than the diameter of said cartridges. Air jets are strategically located over said holes and in proximity to allow the jets to deflect the open end of spent cartridges allowing said cartridges to pass through the holes while allowing the heavier closed end live cartridges to pass further along the track.
f. Ducts under the sorting track holes to guide the spent cartridges passing through the sorting holes. The spent cartridges passing through the holes are guided by a duct to fall into an appropriate container.
g. An outlet at the end of the sorting track to allow the live cartridges remaining in the track to fall into an appropriate container separate from the spent cartridges.

2. A machine capable of separating live ammunition from spent cartridges as described in claim 1 except having a plurality of tracks and chutes to increase the thruput capacity of the machine said tracks and chutes as described in claim 1 being in series with each other.

3. A machine capable of separating live ammunition from spent cartridges as described in claim 1 except having a plurality of tracks and chutes to increase the thruput capacity of the machine said tracks and chutes as described in claim 1 being in parallel with each other.
